(19) United States
(12) Patent Application Publication
(10) Pub. No.: US 2007/0248860 A1
(43) Pub. Date: Oct. 25, 2007

(54) Integrated exhaust combustor and thermal recovery for fuel cells

(76) Inventors: Michael Penev, Albany, NY (US); Christopher J. Chuah, Clifton Park, NY (US); Richard H. Cutright, Corinth, NY (US)

Correspondence Address: TROP PRUNER & HU, PC, 1616 S. VOSS ROAD, SUITE 750, HOUSTON, TX, 77057-2631, US

(21) Appl. No.: 11/600,383

(22) Filed: Nov. 16, 2006

Related U.S. Application Data
(60) Provisional application No. 60/793,893, filed on Apr. 21, 2006.

(51) Int. Cl. H01M 8/04; A01G 13/06

(52) U.S. Cl. 429/26; 431/18

(57) ABSTRACT

An apparatus includes a combustor and a thermal recovery device that is integrated with the combustor. The combustor produces an exhaust flow in response to an exhaust flow from an electrochemical cell.

This application claims the benefit under 35 U.S.C. §119(e) to U.S. Provisional Application Ser. No. 60/793,893, entitled “INTEGRATED EXHAUST COMBUSTOR AND THERMAL RECOVERY FOR FUEL CELLS,” which was filed on Apr. 21, 2006, and is hereby incorporated by reference in its entirety.

### BACKGROUND

The invention generally relates to an integrated exhaust combustor and thermal recovery for fuel cells.

A fuel cell is an electrochemical device that converts chemical energy directly into electrical energy. There are many different types of fuel cells, such as a solid oxide fuel cell (SOFC), a molten carbonate fuel cell, a phosphoric acid fuel cell, a methanol fuel cell and a proton exchange member (PEM) fuel cell.

As a more specific example, a PEM fuel cell includes a PEM membrane, which permits only protons to pass between an anode and a cathode of the fuel cell. A typical PEM fuel cell may employ polysulfonic-acid-based ionomers and operate in the 50° Celsius (C.) to 75° temperature range. Another type of PEM fuel cell may employ a phosphoric-acid-based polybenziamidazole (PBI) membrane that operates in the 150° to 200° temperature range.

At the anode of the PEM fuel cell, diatomic hydrogen (a fuel) is reacted to produce protons that pass through the PEM. The electrons produced by this reaction travel through circuitry that is external to the fuel cell to form an electrical current. At the cathode, oxygen is reduced and reacts with the protons to form water. The anodic and cathodic reactions are described by the following equations:

H₂→2H⁺+2e⁻ at the anode of the cell, and Equation 1

O₂+4H⁺+4e⁻→2H₂O at the cathode of the cell. Equation 2

A typical fuel cell has a terminal voltage near one volt DC. For purposes of producing much larger voltages, several fuel cells may be assembled together to form an arrangement called a fuel cell stack, an arrangement in which the fuel cells are electrically coupled together in series to form a larger DC voltage (a voltage near 100 volts DC, for example) and to provide more power.

The fuel cell stack may include flow plates (graphite composite or metal plates, as examples) that are stacked one on top of the other, and each plate may be associated with more than one fuel cell of the stack. The plates may include various surface flow channels and orifices to, as examples, route the reactants and products through the fuel cell stack. Several PEMs (each one being associated with a particular fuel cell) may be dispersed throughout the stack between the anodes and cathodes of the different fuel cells. Electrically conductive gas diffusion layers (GDLs) may be located on each side of each PEM to form the anode and cathodes of each fuel cell. In this manner, reactant gases from each side of the PEM may leave the flow channels and diffuse through the GDLs to reach the PEM.

### SUMMARY

In an embodiment of the invention, an apparatus includes a combustor and a thermal recovery device that is integrated with the combustor. The combustor produces an exhaust flow in response to an exhaust flow from an electrochemical cell.

In another embodiment of the invention, a technique includes communicating a first exhaust flow from an electrochemical cell to a combustor that is disposed in a chamber of a housing. The technique includes using the chamber as a conduit to communicate a second exhaust flow from the combustor to a thermal recovery device, which is also disposed in the chamber.

Advantages and other features of the invention will become apparent from the following drawing, description and claims.

### BRIEF DESCRIPTION OF THE DRAWING

FIG. 1 is a schematic diagram of a fuel cell system according to an embodiment of the invention.

FIG. 2 is a perspective view of an integrated exhaust combustor and thermal recovery assembly of FIG. 1 according to an embodiment of the invention.

FIG. 3 is a cross-sectional diagram taken along line 3-3 of FIG. 2 according to an embodiment of the invention.

FIG. 4 is a perspective view of an integrated exhaust combustor and thermal recovery assembly according to another embodiment of the invention.

### DETAILED DESCRIPTION

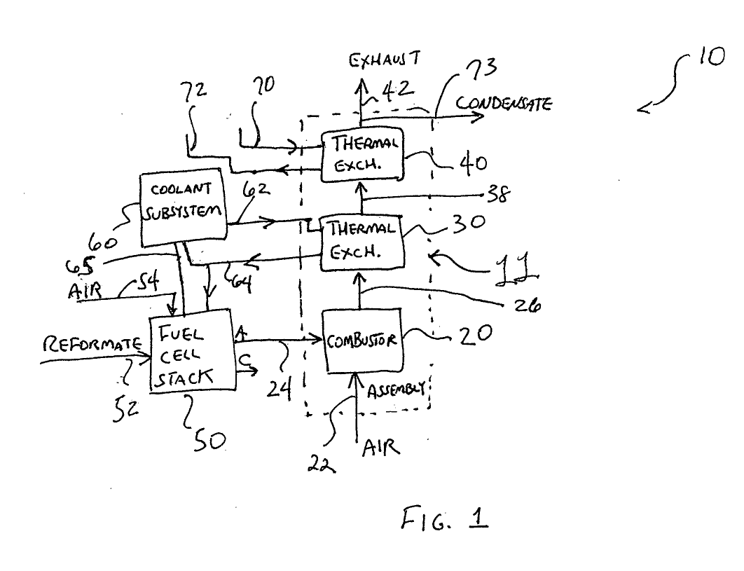

Referring to FIG. 1, an embodiment 10 of a fuel cell system in accordance with an embodiment of the invention includes a fuel cell stack 50, which receives an incoming air flow (i.e., an oxidant flow) at its cathode inlet 54 and an incoming reformate flow (i.e., a fuel flow) at its anode inlet 52. The air and reformate flows are communicated through the cathode and anode chambers, respectively, of the fuel cell stack 50 to promote electrochemical reactions inside the stack 50. In response to these electrochemical reactions, the fuel cell stack 50 produces electrical power for an electrical load (not depicted in FIG. 1) and may produce heat for a particular purpose (such as heating a water tank, for example), depending on the particular embodiment of the invention.

Not all of the reformate is consumed by the electrochemical reactions inside the fuel cell stack 50. Instead, in accordance with some embodiments of the invention, the fuel cell stack 50 produces an anode exhaust flow (at its anode exhaust outlet 24), which contains residual fuel not consumed in the electrochemical reactions, as well as possible undesirable gases and byproducts (N₂ and CO, as examples). For purposes of cleaning up the exhaust as well as producing thermal energy, the anode exhaust of the fuel cell stack 50 may be combusted with air 22 inside a combustor 20, otherwise called an oxidizer.

The heat that is generated by the combustor 20 may be used for such purposes as warming up the fuel cell 50 during its initial start up and supplemental heating (heating a water tank, for example). Therefore, the combustor 20 is part of an integrated exhaust combustor and thermal recovery assembly 11 of the fuel cell system 10. More specifically, in addition to the combustor 20, the assembly 11 includes thermal recovery devices, such as thermal exchangers 30 and 40, for purposes of recovering thermal energy from the heated exhaust flow 26 from the combustor 20 to improve the overall efficiency of the fuel cell system 10.

More specifically, in accordance with some embodiments of the invention, the combustor 20 is integrated with the thermal exchangers 30 and 40 so that there are no thermal barriers or excessive piping between the thermal exchangers 30 and 40 and the combustor 20. This arrangement serves to make the assembly behave like a condensing boiler and contributes to its relatively high additional thermal efficiency.

As a more specific example, in accordance with some embodiments of the invention, the thermal exchanger 30 is a coolant heat exchanger that is directly connected to receive the exhaust flow 26 from the combustor 20 for purposes of transferring thermal energy from the combustor's exhaust to a coolant that circulates through the fuel cell stack 50. Thus, the coolant may flow from a coolant system 60, through a coolant inlet 62 of the thermal exchanger 30, receive thermal energy from the heated exhaust flow 26 from the combustor 20, and then exit the thermal exchanger 30 to flow through an outlet 64 to a coolant inlet of the fuel cell stack 50. During the initial startup of the fuel cell stack 50, the fuel cell system 10 routes the coolant through the aforementioned path for purposes of warming up the stack 50. The coolant returns from the fuel cell stack 50 to a coolant inlet 65 of the coolant subsystem 60.

In accordance with some embodiments of the invention, the thermal exchanger 40 may form a condensing section of the assembly 11. In this regard, the thermal exchanger 40 may receive an exhaust flow 38 from the upstream thermal exchanger 30. The thermal exchanger 40 may receive a coolant via its coolant inlet 70 and output 72 from a coolant source (such as a water heater, for example). The coolant condenses water from the exhaust stream 38 to form a corresponding condensate, which may be removed from the assembly 11 via a condensate line 73. An exhaust 42 from the thermal exchanger 40 exits the assembly 11, in accordance with some embodiments of the invention.

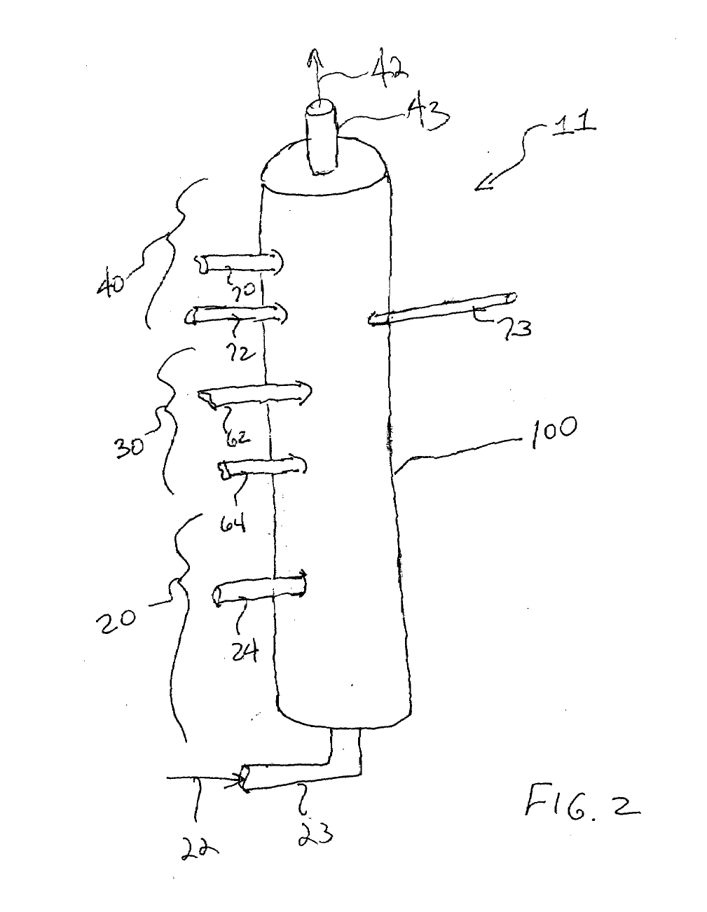

FIG. 2 depicts a schematic diagram of the integrated exhaust combustor and thermal recovery assembly 11 in accordance with some embodiments of the invention. The assembly 11, in general, receives an anode exhaust flow from the fuel cell stack anode exhaust outlet 24; receives the air flow 22 at its inlet 23; and the assembly 11 provides the exhaust flow 42 at its outlet 43. As depicted in FIG. 2, the assembly 11 may be formed from a generally circular cylindrical housing, which is surrounded by an outer insulation layer 100. As described further below, the formation of the assembly 11 using a single housing promotes thermal efficiency without introducing undo restrictions or piping between the assembly's components.

The combustor 20 may take on numerous forms, depending on the particular embodiment of the invention. For example, in accordance with some embodiments of the invention, the combustor 20 may be an exhaust burner that mixes an anode exhaust flow with an oxidant (such as air) to create a substantially funnel-shaped flow, as described in U.S. patent application Ser. No. 11/311,695, entitled “FUEL CELL EXHAUST GAS BURNER,” which was filed on Dec. 19, 2005, and is hereby incorporated by reference. As another example, in accordance with some embodiments of the invention, the combustor 20 may be an oxidizer such as that described in U.S. patent application Ser. No. 11/022,330, entitled “OXIDIZER FOR A FUEL CELL SYSTEM,” which was filed on Dec. 23, 2004, and is hereby incorporated by reference in its entirety. Alternatively, the combustor 20 may be a flare or oxidizer of a conventional design, as can be appreciated by one of ordinary skill in the art. Thus, many variations and designs are possible for the combustor 20, depending on the particular embodiment of the invention.

In accordance with some embodiments of the invention, the thermal exchangers 30 and 40 may be a coiled or plate-type thermal exchangers, depending on the particular embodiment of the invention. As a more specific example, the thermal exchanger 40 may have a design similar to a reactant conditioner described in U.S. patent application Ser. No. 11/319,042, entitled “HUMIDIFYING A REACTANT FLOW OF A FUEL CELL SYSTEM,” which was filed on Dec. 27, 2005, and is hereby incorporated by reference in its entirety.

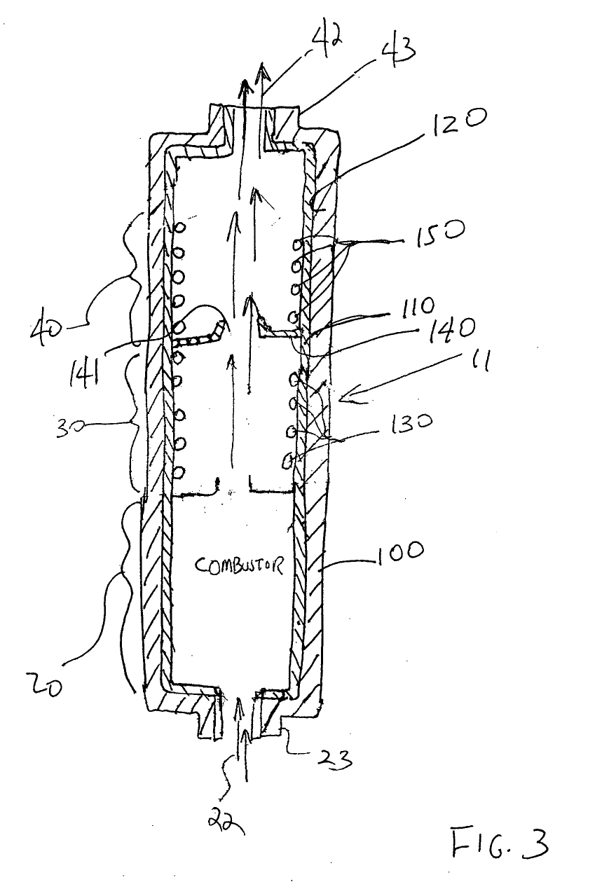

FIG. 3 depicts a cross-sectional diagram taken along line 3-3 of FIG. 2 in accordance with some embodiments of the invention. As shown, in accordance with some embodiments of the invention, the assembly 11 includes a generally circular cylindrical housing 110 that is circumscribed by the outer insulation layer 100. The housing 110, in general, has an internal chamber 120, which contains the combustor 20 and thermal exchangers 30 and 40. In this manner, the chamber 120 serves both a receptacle for containing the combustor 20 and thermal exchanger 30 and 40, and also serves as a conduit for purposes of communicating exhaust flows among the combustor 20 and thermal exchangers 30 and 40. Thus, as shown in FIG. 3, the combustor 20 resides inside the housing 110, as well as coils 130 and 150 of the exchangers 30 and 40, respectively. The exhaust flow from the combustor 20 flows inside the coils 150 of the thermal exchanger 30 and passes from the exchanger 30 through the coil 150 of the thermal exchanger 40. The exhaust flow from the thermal exchanger 40 is communicated through the exhaust outlet 43 to form the corresponding exhaust flow 42 from the assembly 11.

As also depicted in FIG. 3, in accordance with some embodiments of the invention, the assembly 11 includes a condensing pan 140 that is located between the thermal exchangers 30 and 40 for purposes of collecting condensate that is produced by the condensation caused by the coil 150. The condensing pan 140 has a central opening 141 for purposes of permitting communication of the exhaust flow from the exchanger 30 into the exchanger 40. It is noted that the condensate may be collected upstream or downstream of the thermal exchanger 40, depending on the particular embodiment of the invention. Additionally, the condensate line 73 (not depicted in FIG. 3 but shown in FIG. 2) is connected as a drain line to receive the collected condensate from the pan 140.

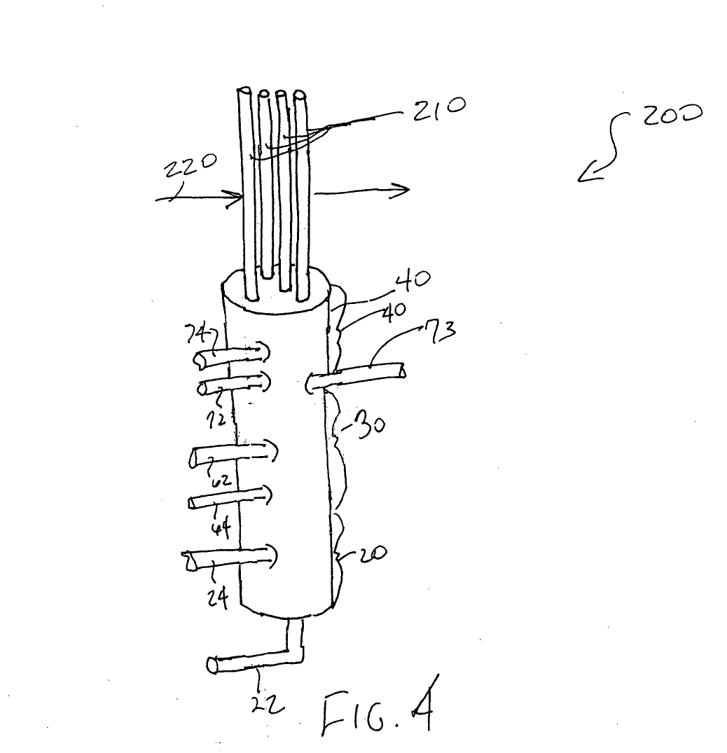

Other variations are possible and are within the scope of the appended claims. For example, referring to FIG. 4, in accordance with some embodiments of the invention, an integrated exhaust combustor and thermal recovery assembly 200 may be used in place of the assembly 11. The assembly 200 has the same general design as the assembly 11, with like reference numerals being used to depict similar elements. However, the assembly 200 has the following differences. In particular, the assembly 200 includes air flow tubes 210 that extend upwardly and receive the exhaust flow from the thermal exchanger 40. The tubes 210 serve as an air preheater to heat a corresponding air flow 220, which may be an air flow to the cathode chamber of the fuel cell stack 50 (see FIG. 1), in accordance with some embodiments of the invention.

Other and/or different thermal recovery devices may be integrated with the combustor 20, in accordance with other embodiments of the invention.

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. An apparatus, comprising:
a combustor to produce a combustor exhaust flow in response to at least in part an electrochemical cell exhaust flow; and
a thermal recovery device integrated with the combustor.

2. The apparatus of claim 1, further comprising:
a housing have a chamber,
wherein the combustor and thermal recovery device are located in the chamber, and the chamber serves as a conduit to communicate the combustor exhaust flow to the thermal recovery device.

3. The apparatus of claim 2, wherein the housing comprises a cylindrical housing.

4. The apparatus of claim 3, further comprising:
an insulation layer circumscribing the housing, the thermal recovery device and the combustor.

5. The apparatus of claim 3, further comprising:
another thermal recovery device located in the chamber,
wherein the chamber serves as a conduit to communicate a flow from the first thermal recovery device to said another thermal recovery device.

6. The apparatus of claim 1, further comprising:
a insulation layer contiguously extending around the combustor and the thermal recovery device.

7. The apparatus of claim 1, further comprising:
another thermal recovery device integrated with the combustor.

8. The apparatus of claim 7, wherein said another thermal recovery device comprises a thermal exchanger.

9. The apparatus of claim 1, wherein the thermal recovery device comprises a thermal exchanger.

10. The apparatus of claim 1, wherein the thermal recovery device comprises an air preheater.

11. A method comprising:
communicating a first exhaust flow from an electrochemical cell to a combustor disposed in a chamber of a housing; and
using the chamber as a conduit to communicate a second exhaust flow from the combustor to a thermal recovery device disposed in the chamber.

12. The method of claim 11, wherein the housing comprises a cylindrical housing.

13. The method of claim 11, providing an insulation layer circumscribing the housing, the thermal recovery device and the combustor.

14. The method of claim 11, further comprising:
using the chamber as a conduit to communicate a third exhaust flow from the first thermal recovery device to another thermal recovery device located in the chamber.

15. The method of claim 14, wherein said another thermal recovery device comprises a thermal exchanger.

16. The method of claim 11, wherein the thermal recovery device comprises a thermal exchanger.

17. The method of claim 11, wherein the thermal recovery device comprises an air preheater.

18. A system comprising:
an electrochemical cell to provide a first exhaust flow; and
an assembly to receive the exhaust flow, the assembly comprising:
a housing comprising a chamber;
a combustor disposed in the chamber to combust the first exhaust flow to generate a second exhaust flow; and
a thermal recovery device located in the chamber to receive the second exhaust flow, the second exhaust flow being communicated to the thermal device via the chamber.

19. The system of claim 18, wherein the chamber comprises a cylinder.

20. The system of claim 18, further comprising an insulation layer covering the housing to insulate both the combustor and the thermal recovery device.

21. The system of claim 18, wherein the thermal recovery device comprises a thermal exchanger.

22. An apparatus comprising:
a cylindrical housing comprising a chamber;
a combustor disposed in the chamber to combust a first exhaust flow produced by a fuel cell with air;
a first thermal exchanger disposed in the chamber to receive a second exhaust flow produced by the combustor, the second exhaust flow being communicated to the first thermal exchanger via the chamber; and
a second thermal exchanger disposed in the chamber to receive a third exhaust flow produced by the first thermal exchanger, the third exhaust flow being communicated to the first thermal exchanger via the chamber.
